(19) United States
(12) Patent Application Publication
(10) Pub. No.: US 2012/0203408 A1
(43) Pub. Date: Aug. 9, 2012

(54) ABNORMALITY DIAGNOSTIC DEVICE FOR VEHICLE AND ABNORMALITY DIAGNOSTIC METHOD FOR VEHICLE

(75) Inventor: Tsubasa Migita, Toyota-shi (JP)

(73) Assignee: TOYOTA JIDOSHA KABUSHIKI KAISHA, Toyota-shi (JP)

(21) Appl. No.: 13/366,860

(22) Filed: Feb. 6, 2012

(30) Foreign Application Priority Data
Feb. 7, 2011 (JP) 2011-023978

(51) Int. Cl. G06F 7/00

(52) U.S. Cl. 701/22

(57) ABSTRACT

An abnormality diagnostic device for a vehicle is provided with a first temperature sensor that detects the temperature of a rear-wheel drive motor, and a HV control computer that monitors the temperature of the rear-wheel drive motor by using the first temperature sensor and controls the rear-wheel drive motor. When a vehicle state satisfies a provisional determination condition indicating a connection abnormality of the first temperature sensor, the HV control computer performs verification processing of raising the temperature of the rear-wheel drive motor and verifying whether a detection value of the first temperature sensor demonstrates a predetermined variation, and establishes diagnosis of the connection abnormality on the basis of a result of the verification processing.

### INCORPORATION BY REFERENCE

The disclosure of Japanese Patent Application No. 2011-023978 filed on Feb. 7, 2011 including the specification, drawings and abstract is incorporated herein by reference in its entirety.

### BACKGROUND OF THE INVENTION

1. Field of the Invention

The invention relates to an abnormality detection device for a vehicle and an abnormality detection method for a vehicle, and more particularly to an abnormality detection device and an abnormality detection method relating to a temperature sensor.

2. Description of Related Art

A variety of temperature sensors that detect temperature, such as an air temperature sensor, are installed on a vehicle as disclosed in Japanese Patent Application Publication No. 10-61479 (JP-A-10-61479). Where temperature detection is impossible, for example due to electric disconnection of such temperature sensors, the performance of vehicle is adversely affected, e.g., fuel consumption is degraded.

Accordingly, electric disconnection of temperature sensors is detected and when such disconnection is detected, the driver is notified of the abnormality, or diagnostic results of disconnection detection are stored in a vehicle controller so that the occurrence of disconnection may be easily discovered in a repair shop.

However, where the accuracy of disconnection detection is poor, erroneous detection occurs, the driver may be unnecessarily put to trouble, or unnecessary replacement of parts may be performed during the repair. JP-A-10-61479 discloses a technique relating to improvement of abnormality detection accuracy relating to an air temperature sensor.

Electric automobiles and hybrid automobiles have become popular in recent years and the number of vehicles having installed thereon an electric motor for driving the vehicle or a high-voltage and high-capacitance power storage device for driving the motor has increased. In some vehicle, a motor for rear-wheel drive is installed separately from a drive for front-wheel drive so that four-wheel drive could be realized.

The problem associated with the occurrence of erroneous detection in temperature sensors in the vehicles of such a configuration and techniques for preventing such erroneous defection have not been disclosed in JP-A-10-61479.

### SUMMARY OF THE INVENTION

The invention provides a vehicle having a rear-wheel drive motor in which the accuracy of failure detection in a temperature sensor provided at the rear-wheel drive motor is increased.

An abnormality diagnostic device according to the first aspect of the invention is an abnormality diagnostic device for a vehicle having a rear-wheel drive motor, including a first temperature sensor that detects a temperature of the rear-wheel drive motor, and a control device that monitors the temperature of the rear-wheel drive motor by using the first temperature sensor and controls the rear-wheel drive motor. When a vehicle state satisfies a provisional determination condition indicating a connection abnormality of the first temperature sensor, the control device performs verification processing of raising the temperature of the rear-wheel drive motor and verifying whether a detection value of the first temperature sensor demonstrates a predetermined variation, and establishes diagnosis of the connection abnormality on the basis of a result of the verification processing.

An abnormality diagnostic method according to the second aspect of the invention is an abnormality diagnostic method for a vehicle having a rear-wheel drive motor, the vehicle being provided with a first temperature sensor that detects a temperature of the rear-wheel drive motor; and a control device that monitors the temperature of the rear-wheel drive motor by using the first temperature sensor and controls the rear-wheel drive motor, the abnormality diagnostic method including: determining whether a vehicle state satisfies a provisional determination condition indicating a connection abnormality of the first temperature sensor; performing verification processing of raising the temperature of the rear-wheel drive motor and verifying whether a detection value of the first temperature sensor demonstrates a predetermined variation, when the provisional determination condition is satisfied; and establishing diagnosis of the connection abnormality on the basis of a result of the verification processing.

According to the above-described aspects of the invention, the accuracy of failure detection in a temperature sensor provided at the rear-wheel drive motor is increased. Therefore, the driver may be prevented from being put unnecessarily to trouble and unnecessary replacement of parts during the repair may be prevented.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram illustrating the configuration of a vehicle according to an embodiment of the invention;

FIG. 2 is an explanatory drawing illustrating the positions at which the constituent elements of the vehicle shown in FIG. 1 are arranged in the vehicle;

FIG. 3 relates to the present embodiment and shows a configuration that is used to detect the temperature of a motor generator;

FIG. 4 relates to the present embodiment and shows how a voltage value detected by a temperature sensor and a hybrid (HV) control computer changes depending on temperature;

FIG. 5 is a flowchart for explaining the diagnostic processing of a temperature sensor performed in the present embodiment; and

FIG. 6 is a flowchart illustrating the processing of a variation example of the present embodiment.

### DETAILED DESCRIPTION OF EMBODIMENTS

An embodiment of the invention will be explained below in greater detail with reference to the appended drawings. In the drawings, like or corresponding parts are assigned with like reference numerals and the redundant explanation thereof will be omitted.

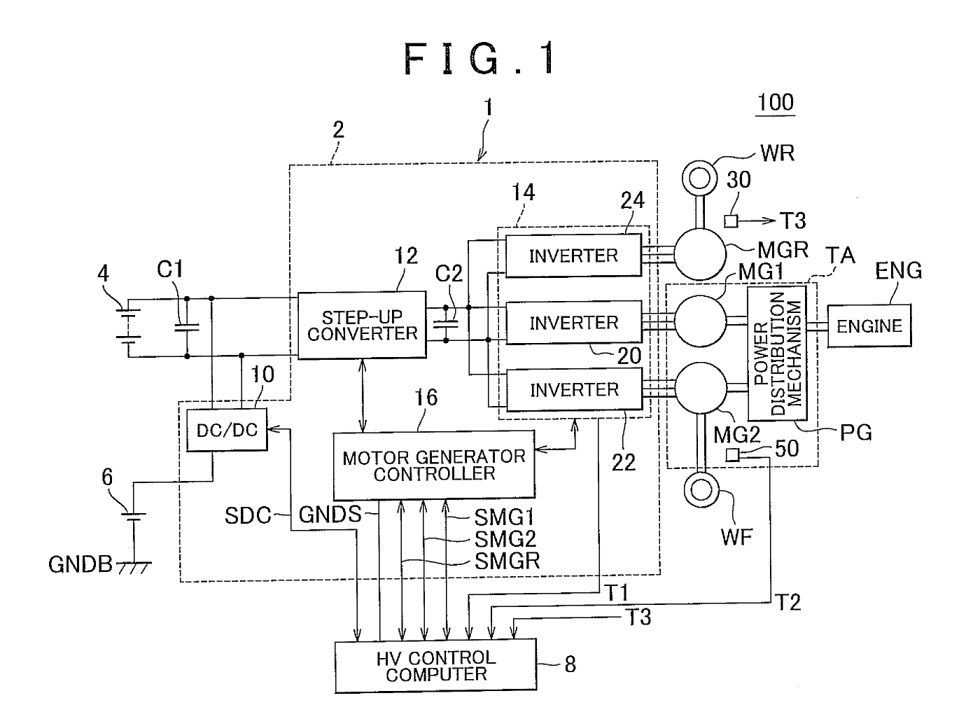

FIG. 1 is a block diagram illustrating the configuration of a vehicle 100 according to an embodiment of the invention.

Referring to FIG. 1, the vehicle 100 is a hybrid automobile and includes a high-voltage battery 4, an auxiliary battery 6, a power control unit 1, a hybrid (HV) control computer 8, a transaxle TA, a motor generator MGR, an engine ENG, front wheels WF, and rear wheels WR. The transaxle TA includes motor generators MG1, MG2 and a power distribution mechanism PG.

The power distribution mechanism PG is coupled to the engine ENG and the motor generators MG1, MG2 and distributes the power therebetween. For example, a planetary gear mechanism having three rotating shafts of a sun gear, a planetary gear, and a ring gear may be used as the power distribution mechanism. These three rotating shafts are connected to rotating shafts of the engine ENG and motor generators MG1, MG2, respectively. A reducer corresponding to the rotating shaft of the motor generator MG2 may be further incorporated inside the power distribution mechanism PG.

The rotating shaft of the motor generator MG2 drives the front wheels WF via a reducer and a differential gear (not shown in the figure). The rotating shaft of the motor generator MGR drives the rear wheels WR via a reducer and a differential gear (not shown in the figure).

A secondary battery such as a nickel hydride battery and a lithium ion battery, a fuel cell or the like may be used as the high-voltage battery 4. For example a 12 V lead storage battery may be used as the auxiliary battery 6.

The power control unit 1 includes a housing 2 and a step-up converter 12, an inverter intelligent power module (IPM) 14, a motor generator controller 16, and a direct current/direct current (DC/DC) converter 10, each accommodated in the housing 2.

The inverter IPM 14 includes inverters 20, 22, 24. The step-up converter 12 step-ups a terminal voltage of the high-voltage battery 4 and supplies the increased voltage to the inverters 20, 22, 24.

The inverter 20 converts a direct current (DC) voltage supplied from the step-up converter 12 into a three-phase alternating current and outputs the current to the motor generator MG1. The step-up converter 12 is constituted, for example, by a reactor, an insulated gate bipolar transistor (IGBT) element, and a diode.

The inverter 20 receives the increased voltage from the step-up converter 12 and drives the motor generator MG1, for example, in order to start the engine ENG. Further, the inverter 20 also returns to the step-up converter 12 the power that is generated by the motor generator MG1 under the effect of the mechanical power transmitted from the engine ENG. In this case, the step-up converter 12 is controlled by the motor generator controller 16 so as to operate as a step-down circuit.

The inverter 20 includes a U phase arm, a V phase arm, and a W phase arm connected in parallel between a power supply line and a ground line. Each arm of the inverter 20 includes two IGBT elements connected in series between the power supply line and the ground line and two diodes connected in parallel to the respective two IGBT elements.

The motor generator MG1 is a three-phase permanent magnet synchronous motor, and three (U, V, W phase) coils thereof are connected each by one end thereof to a common central portion. Other end of each coil is connected to the arm of the corresponding phase of the inverter 20.

The inverter 22 is connected in parallel with the inverter 20 to the step-up converter 12. The inverter 22 converts the DC voltage outputted by the step-up converter 12 into a three-phase alternating current and outputs the current to the motor generator MG2 that drives the wheels. Further, the inverter 22 returns the power generated in the motor generator MG2 in response to regenerative braking to the step-up converter 12. In this case, the step-up converter 12 is controlled by the motor generator controller 16 so as to operate as a step-down circuit.

The configuration of the inverter 22 is similar to that of the inverter 20 and the redundant explanation thereof is herein omitted. The motor generator MG2 is a three-phase permanent magnet synchronous motor, and three (U, V, W phase) coils thereof are connected each by one end thereof to a common central portion. Other end of each coil is connected to the arm of the corresponding phase of the inverter 22.

The inverter 24 is connected in parallel with the inverters 20, 22 to the step-up converter 12. The inverter 24 converts the DC voltage outputted by the step-up converter 12 into a three-phase alternating current and outputs the current to the motor generator MGR that drives the rear wheels. Further, the inverter 24 returns the power generated in the motor generator MGR in response to regenerative braking to the step-up converter 12: In this case, the step-up converter 12 is controlled by the motor generator controller 16 so as to operate as a step-down circuit.

The configuration of the inverter 24 is similar to that of the inverter 20 and the redundant explanation thereof is herein omitted. The motor generator MGR is a three-phase permanent magnet synchronous motor, and three (U, V, W phase) coils thereof are connected each by one end thereof to a common central portion. The other end of each coil is connected to the arm of the corresponding phase of the inverter 24.

The motor generator controller 16 receives the torque command values, motor revolution speeds and motor current values of the three motor generators, the terminal voltage of the high-voltage battery 4, the step-up voltage of the step-up converter 12, and values of battery current. The motor generator controller 16 outputs a step-up command, a step-down command, and an operation prohibition command to the step-up converter 12.

The motor generator controller 16 outputs to the inverter 20 a drive instruction to convert the DC voltage that is the output of the step-up converter 12 into an alternating current (AC) voltage for driving the motor generator MG1 and a regeneration instruction to convert the AC voltage generated by the motor generator MG1 into a DC voltage and return the converted voltage to the step-up converter 12.

Likewise, the motor generator controller 16 outputs to the inverter 22 a drive instruction to convert the DC voltage into an AC voltage for driving the motor generator MG2 and a regeneration instruction to convert the AC voltage generated by the motor generator MG2 into a DC voltage and return the converted voltage to the step-up converter 12.

Likewise, the motor generator controller 16 outputs to the inverter 24 a drive instruction to convert the DC voltage into an AC voltage for driving the motor generator MGR and a regeneration instruction to convert the AC voltage generated by the motor generator MGR into a DC voltage and return the converted voltage to the step-up converter 12.

The DC/DC converter 10 reduces the voltage of the high-voltage battery 4 to charge the auxiliary battery 6 or supplies power to a load such as headlights (not shown in the figure) connected to the auxiliary battery 6. The DC/DC converter 10 exchanges control signals SDC with the HV control computer 8.

The HV control computer 8 is connected to the motor generator controller 16 by signal lines by which control signals SMG1, SMG2, SMGR that control the motor generators MG1, MG2, MGR, respectively, are exchanged with the motor generator controller 16 and a ground line by which a control ground GNDS that is a reference for the signals is connected to the motor generator controller 16.

The signal lines for exchanging the control signals SMG1, SMG2, SMGR, SDC and the ground line connecting the control ground GNDS are connected from the inside of the power control unit 1 to the HV control computer 8.

The temperature sensor 30 is mounted on the motor generator MGR. A temperature T3 of the motor generator MGR that has been detected by the temperature sensor 30 is transmitted to the HV control computer 8. An inverter temperature T1 is transmitted from the inverter IPM 14 to the HV control computer 8. The inverter temperature T1 is detected by a temperature detection element incorporated in the inverter IPM 14. Further, a motor temperature T2 detected by a temperature sensor 50 mounted on the motor generator MG2 is transmitted from the transaxle TA to the HV control computer 8.

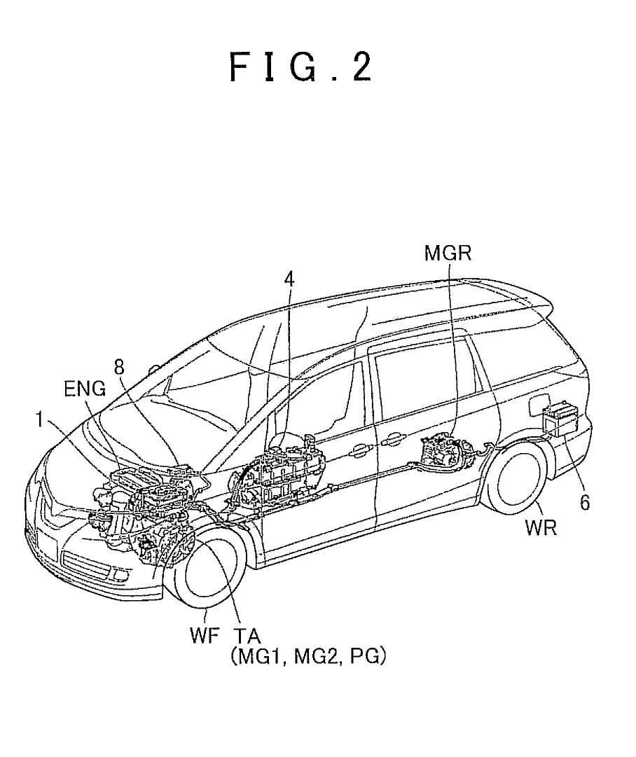

FIG. 2 is an explanatory drawing illustrating the positions at which the constituent elements of the vehicle shown in FIG. 1 are arranged in the vehicle 100.

Referring to FIG. 2, the power control unit 1, engine ENG and transaxle TA that drives the front wheels WF are disposed in an engine room in front of the driver's seat in the vehicle. A battery pack in which the high-voltage battery 4 is accommodated is disposed inside the vehicle cabin. In the rear part of the vehicle, the motor generator MGR that drives the rear wheels WR is disposed close to the rear wheels, and the auxiliary battery 6 is disposed close to the rearmost portion of the vehicle. With such an arrangement, the difference in temperature between the power control unit 1 and the transaxle TA, which are positioned close to each other, is not that large. By contrast, the motor generator MGR is set apart from the power control unit 1 and transaxle TA and therefore the difference in temperature therebetween may easily be large.

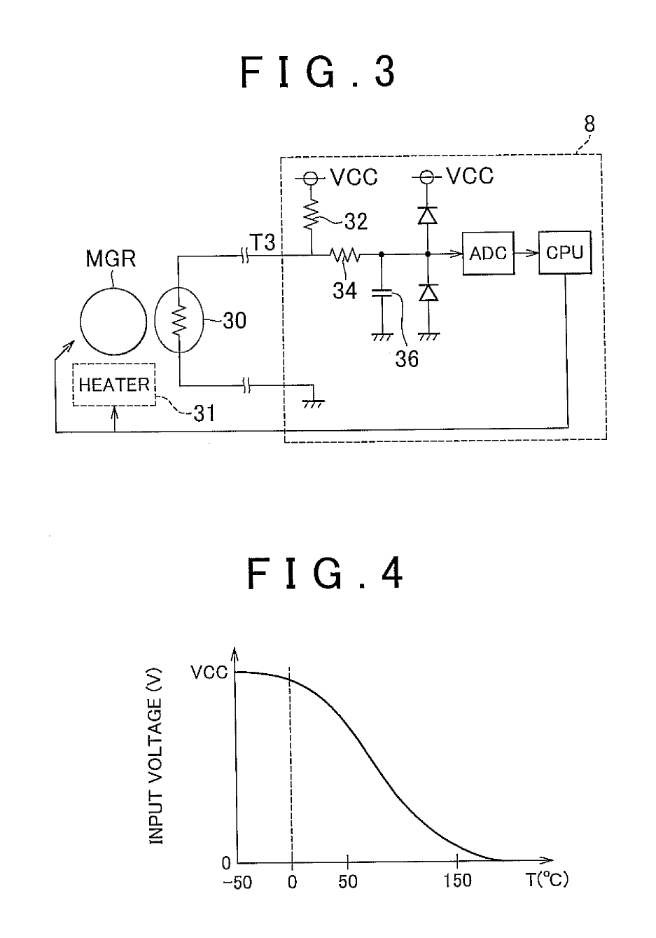

FIG. 3 shows a configuration for detecting the temperature of the motor generator MGR. Referring to FIG. 3, the temperature sensor 30 is mounted on the motor generator MGR. A thermistor in which the resistance value changes according to variations in temperature may be used as the temperature sensor 30.

The HV control computer 8 includes resistors 32, 34, a capacitor 36, an analog to digital (AD) converter (ADC), and a central processing unit (CPU). A voltage determined by the resistance ratio of the resistor 34 and the temperature sensor 30 is inputted via the resistor 34 to the AD converter ADC and taken in as a digital value by the CPU.

FIG. 4 shows how the voltage value detected by the temperature sensor 30 and the HV control computer 8 changes depending on temperature.

Referring to FIGS. 3 and 4, the input voltage inputted to the AD converter ADC is close to VCC when the temperature is low and close to 0 V when the temperature becomes higher. Therefore, when the temperature sensor 30 is close to 50 degrees below zero, the input voltage becomes VCC. However, as follows from FIG. 3, even when a disconnection failure occurs in the temperature sensor 30 or the wiring portion thereof, the input terminal is pulled up by the resistor 32 and the input voltage to the AD converter ADC rather becomes VCC.

A connection abnormality (disconnection or power supply short circuit) of the temperature sensor (rear motor temperature sensor) 30 is detected when only the temperature T3 of the motor generator MGR is an abnormal lower temperature, even if the temperature T2 of the motor generator MG2 and the inverter temperature T1 are sufficiently high.

However, in cold regions, such detection condition is sometimes satisfied even when there is no connection abnormality in the temperature sensor 30. In such a case, erroneous diagnosis of connection abnormality occurs, the driver may be unnecessarily put to trouble, or unnecessary replacement of parts may be performed during the repair. Therefore, it is desirable to prevent such erroneous detection.

In particular, when the shift range is in a parking range (P range), an electric current flows to the motor generators MG1, MG2 and zero torque control is performed. Therefore, the inverter temperature T1 and the temperature T2 of the motor generator MG2 become higher than the external temperature. However, since no current flows to the motor generator MGR, the temperature T3 is almost equal to the external temperature. Therefore, in cold regions erroneous diagnosis easily occurs when the shift range is set to the P range.

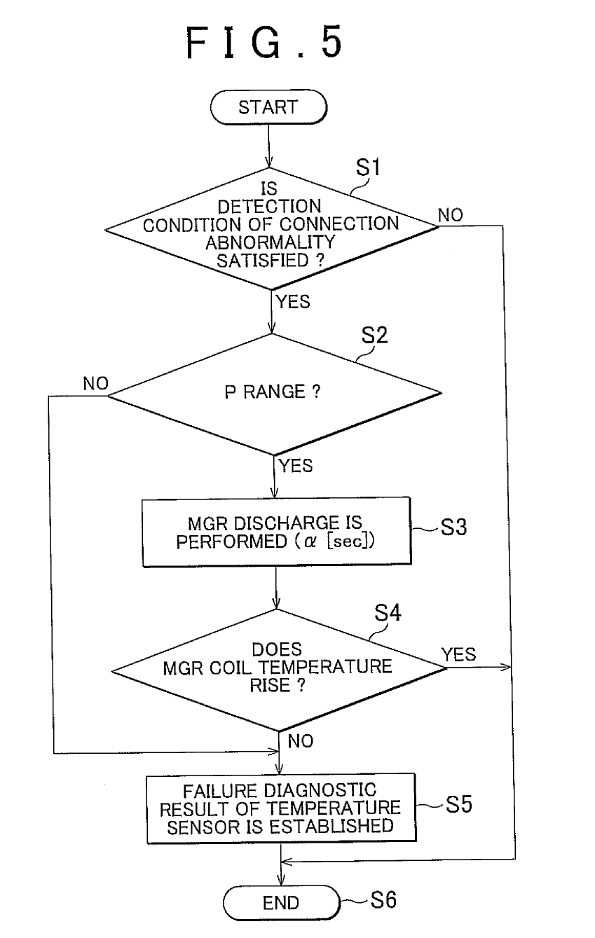

FIG. 5 is a flowchart for explaining the process of temperature sensor diagnosis performed in the present embodiment.

Referring to FIGS. 1 and 5, where the processing is started, the HV control computer 8 determines whether the detection results of various sensors have been plugged into the detection condition of connection abnormality. For example, whether the three conditions, namely, that the temperature of the motor generator MGR is equal to or lower than a threshold Th1 (for example, −35° C.), the temperature of the motor generator MG2 is equal to or higher than a threshold Th2 (for example, 0° C.), and the inverter temperature is equal to or higher than a threshold Th3 (for example, 24° C.), are maintained over a predetermined time (for example, 2 sec), it may be taken as a detection condition of connection abnormality.

Where the detection condition of connection abnormality is not satisfied in step S1, the processing advances to step S6 and the processing ends without diagnosing a failure. When the detection condition is satisfied in step S1, the processing advances to step S2. In step S2, it is determined whether the shift range is the P range. When the shift range is the P range, the motor generators MG1, MG2 are energized in a state in which the zero torque control has been performed, as has been explained hereinabove. Therefore, the temperature of the inverter IPM 14 and motor generator MG2 becomes higher than the external temperature. Meanwhile, since the motor generator MGR is not energized, the temperature thereof is almost equal to the external temperature. When the vehicle runs, the motor generator MGR is also energized and the temperature thereof rises.

Therefore, the condition of step S1 is easier satisfied and erroneous detection easier occurs when the vehicle is stopped and the shift range is set to the P range than when the vehicle runs. As a consequence, when the shift range is not in the P range in step S2, the processing advances to step S5 and the diagnostic result of “connection abnormality is present” is established. Meanwhile, where the shift range is the P range in step S2, the processing is executed in steps S3, S4 such that the temperature of the motor generator MGR rises and it is verified whether the detection temperature rises and whether the connection abnormality has actually occurred.

First, in step S3, the MGR discharge processing is executed for a sec. The MGR discharge processing as referred to herein is a processing of raising the temperature of the motor generator MGR by causing the flow of electric current (d-axis current) that generates no torque in the start coil of the motor generator MGR. The conduction period of α sec is set by determining experimentally the time interval sufficient to enable the detection of temperature increase with the temperature sensor 30.

In step S4, it is determined whether the coil temperature of the motor generator MGR that has been detected by the temperature sensor 30 has risen. When the temperature is determined in step S4 to have risen, no connection abnormality has occurred in the temperature sensor 30. Therefore, the processing advances to step S6 and the control ends. Meanwhile, where no changes have been found in step S4 in the temperature detected by the temperature sensor 30, the processing advances to step S5. In step S5, the failure diagnostic result of the temperature sensor 30 is established as “connection abnormality is present”, the processing then advances to step S6 and the control ends.

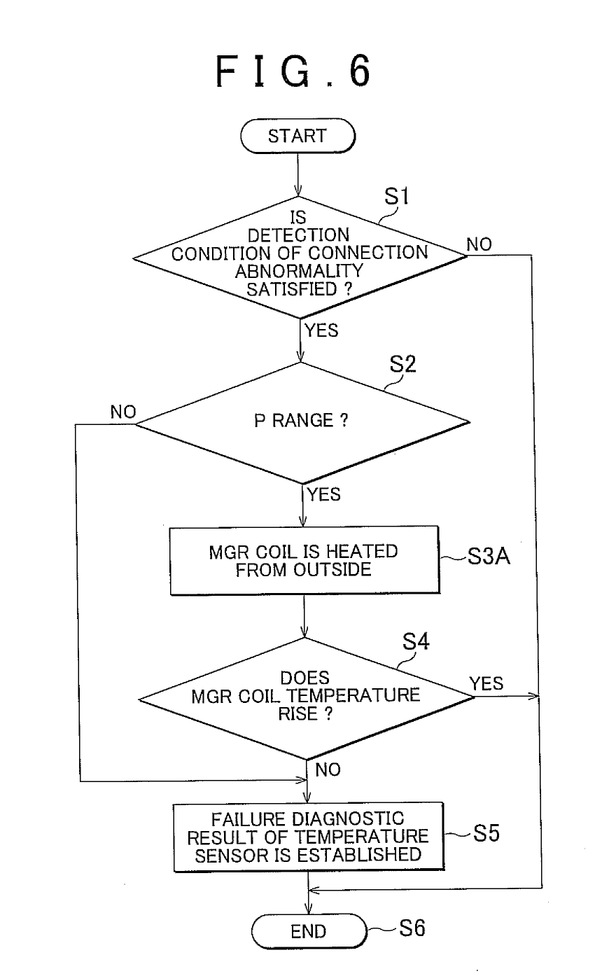

FIG. 6 is a flowchart illustrating the processing according to a variation example of the embodiment. The flowchart shown in FIG. 6 includes the processing of step S3A instead of the processing of step S3 in the flowchart shown in FIG. 5. Other processing operations are similar to those illustrated by FIG. 5 and the explanation thereof is herein omitted.

In step S3A in FIG. 6, the processing foe hating the coil of the motor generator MGR from the outside is executed as the processing of heating the MGR. More specifically, for example, the motor generator MGR is provided with a heater, and the processing of actuating the heater may be performed.

With the processing illustrated by FIGS. 5 and 6, the determination of connection abnormality of the temperature sensor 30 is performed more accurately. Therefore, the driver may be prevented from being put unnecessarily to trouble and unnecessary replacement of parts during the repair may be prevented.

Finally, the abnormality diagnostic device for a vehicle of the present embodiment will be overviewed by referring again to FIG. 1. The abnormality diagnostic device for a vehicle includes a first temperature sensor 30 that detects the temperature of the rear-wheel drive motor MGR, and the HV control computer 8 that monitors the temperature of the rear-wheel drive motor MGR by using the first temperature sensor 30 and controls the rear-wheel drive motor MGR. When a vehicle state satisfies provisional determination conditions indicating a connection abnormality of the first temperature sensor 30 (the following three conditions: the temperature of the motor generator MGR is equal to or lower than a threshold Th1, the temperature of the motor generator MG2 is equal to or higher than a threshold Th2, and the inverter temperature is equal to or higher than a threshold Th3), the HV control computer 8 performs verification processing of raising the temperature of the rear-wheel drive motor MGR and verifying whether a detection value of the first temperature sensor 30 demonstrates a predetermined variation, and establishes diagnosis of the connection abnormality on the basis of a result of the verification processing.

It is preferred that the vehicle further include the front-wheel drive motor MG2 and the power control unit 1 that performs power control of the front-wheel drive motor MG2 and the rear-wheel drive motor MGR. As shown in FIG. 2, the front-wheel drive motor MG2 and the power control unit 1 are disposed in a front portion (engine room) of the vehicle. The rear-wheel drive motor MGR is disposed in a rear portion of the vehicle (close to the rear wheels) that is set apart from the front portion. The abnormality diagnostic device is further provided with the second temperature sensor 50 that detects the temperature of the front-wheel drive motor MG2 or the temperature of the power control unit 1. The provisional determination condition, which is used for determination in step S1 illustrated by FIG. 5, includes the condition of a difference between the detection value of the first temperature sensor 30 and the detection value of the second temperature sensor 50 being greater than a threshold. For example, where the determination condition is “the rear-wheel drive motor temperature T(MGR)≦Th1” and “the front-wheel drive motor temperature T(MG2)≧Th2”, it is determined that the difference between the detection value of the first temperature sensor 30 and the detection value of the second temperature sensor 50 is equal to or greater than a threshold “Th2-Th1”. Likewise, where “the inverter temperature T(INV)≧Th3” is taken as a determination condition instead of the condition relating to the front-wheel drive motor temperature or in addition thereto, the difference between the rear-wheel drive motor temperature T(MGR) and the inverter temperature T(INV) is determined by a threshold “Th3-Th1”.

It is more preferred that when a shift range is set to a parking range, the HV control computer 8 control the rear-wheel drive motor MGR to a non-energized state while maintaining the power control unit 1 and the front-wheel drive motor MG2 in an energized state. When the shift range is set to a drive range, the HV control computer 8 establishes the diagnosis of connection abnormality of the first temperature sensor 30 immediately after the provisional determination condition is satisfied, and when the shift range is set to the parking range, the computer performs the verification processing when the provisional determination condition is satisfied and then establishes the diagnosis of connection abnormality of the first temperature sensor 30.

It is more preferred that the HV control computer 8 cause an electric current that generates no torque to flow in a coil of the rear-wheel drive motor MGR and raise the temperature of the rear-wheel drive motor MGR when performing the verification processing.

It is more preferred that the HV control computer 8 actuate the heater 31 provided at the rear-wheel drive motor MGR and raise a temperature of the rear-wheel drive motor MGR when performing the verification processing.

The embodiments disclosed herein should be construed as merely illustrative and not restrictive in all of the aspects thereof. The scope of the invention is represented by the claims, rather by the description of the abovementioned embodiments, and intended to include all of the variations that are equivalent in scope and meaning to the claims.

What is claimed is:

1. An abnormality diagnostic device for a vehicle having a rear-wheel drive motor, comprising:
a first temperature sensor that detects a temperature of the rear-wheel drive motor; and
a control device that monitors the temperature of the rear-wheel drive motor by using the first temperature sensor and controls the rear-wheel drive motor, wherein
when a vehicle state satisfies a provisional determination condition indicating a connection abnormality of the first temperature sensor, the control device performs verification processing of raising the temperature of the rear-wheel drive motor and verifying whether a detection value of the first temperature sensor demonstrates a predetermined variation, and establishes diagnosis of the connection abnormality on the basis of a result of the verification processing.

2. The abnormality diagnostic device according to claim 1, wherein:
the vehicle further includes a front-wheel drive motor, and a power control unit that performs power control of the front-wheel drive motor and the rear-wheel drive motor;
the front-wheel drive motor and the power control unit are disposed in a front portion of the vehicle;
the rear-wheel drive motor is disposed in a rear portion of the vehicle that is positioned further rearward than the front portion;
the abnormality diagnostic device further comprises a second temperature sensor that detects a temperature of the front-wheel drive motor or a temperature of the power control unit; and
the provisional determination condition includes a condition that a difference between a detection value of the first temperature sensor and a detection value of the second temperature sensor is greater than a threshold.

3. The abnormality diagnostic device according to claim 2, wherein:
when a shift range is set to a parking range, the control device controls the rear-wheel drive motor to a non-energized state while maintaining the power control unit and the front-wheel drive motor in an energized state, and when the provisional determination condition is satisfied, the control device performs the verification processing and then establishes the diagnosis of connection abnormality of the first temperature sensor; and
when the shift range is set to a drive range, the control device establishes the diagnosis of connection abnormality of the first temperature sensor immediately after the provisional determination condition is satisfied.

4. The abnormality diagnostic device according to claim 2, wherein:
the control device causes an electric current that generates no torque to flow in a coil of the rear-wheel drive motor and raises a temperature of the rear-wheel drive motor when performing the verification processing.

5. The abnormality diagnostic device according to claim 2, wherein:
the control device actuates a heater provided at the rear-wheel drive motor and raises a temperature of the rear-wheel drive motor when performing the verification processing.

6. The abnormality diagnostic device according to claim 1, wherein the vehicle is a four-wheel drive vehicle.

7. An abnormality diagnostic method for a vehicle having a rear-wheel drive motor, the vehicle being provided with a first temperature sensor that detects a temperature of the rear-wheel drive motor; and a control device that monitors the temperature of the rear-wheel drive motor by using the first temperature sensor and controls the rear-wheel drive motor,
the abnormality diagnostic method comprising:
determining whether a vehicle state satisfies a provisional determination condition indicating a connection abnormality of the first temperature sensor;
performing verification processing of raising the temperature of the rear-wheel drive motor and verifying whether a detection value of the first temperature sensor demonstrates a predetermined variation, when the provisional determination condition is satisfied; and
establishing diagnosis of the connection abnormality on the basis of a result of the verification processing.
